(19) United States
(12) Patent Application Publication
(10) Pub. No.: US 2006/0185294 A1
(43) Pub. Date: Aug. 24, 2006

(54) Flexible clip

(75) Inventors: Paul J. Langer, Bay Village, OH (US); Timothy B. McGlinchy, Twinsburg, OH (US)

Correspondence Address: WATTS HOFFMANN CO. L.P.A., 1100 SUPERIOR AVE., SUITE 1750, CLEVELAND, OH, 44114, US

(73) Assignee: GED INTEGRATED SOLUTIONS, INC.

(21) Appl. No.: 11/352,482

(22) Filed: Feb. 10, 2006

Related U.S. Application Data
(60) Provisional application No. 60/651,822, filed on Feb. 10, 2005.

(51) Int. Cl. E06B 3/70

(52) U.S. Cl. 52/456

(57) ABSTRACT

A muntin clip for use with a spacer frame or window sash having an elongated channel extending around an inner periphery of the frame. The disclosed muntin clip has a spacer frame or sash engaging body for insertion into a channel of the spacer frame. A flexible body portion flexes from a first configuration to a second configuration as the clip is pushed into the spacer frame to exert an outward force against walls of the spacer frame bounding the frame channel. The disclosed clip also includes a muntin bar engaging body attached to the spacer frame engaging body that includes a flexible portion that flexes as the muntin bar engaging body is pushed into the muntin bar to frictionally engage the muntin bar.

### CROSS REFERENCE TO RELATED APPLICATION

The present application claims priority from U.S. provisional application Ser. No. 60/651,822 filed Feb. 10, 2005 entitled Universal Muntin Clip which is incorporated herein by reference.

### FIELD OF THE INVENTION

The present invention relates to an insulating glass unit and more particularly to an improved universal, adjustable clip for window muntins or the like.

### BACKGROUND ART

Insulating glass units (IGUs) are used in windows to reduce heat loss from building interiors during cold weather. IGUs are typically formed by a spacer assembly sandwiched between glass lites. A spacer assembly usually comprises a metal frame extending peripherally about the unit, a sealant material adhered to both the glass lites and the frame, and a desiccant for absorbing atmospheric moisture within the unit. The margins of the glass lights are flush with or extend slightly outwardly from the outer periphery of the frame. The sealant extends continuously about the frame's periphery and its opposite sides so that the space within the IGU is hermetic.

A successful prior art IGU construction has employed tubular, roll formed aluminum or steel spacer frame elements connected at their ends to form a square or rectangular spacer frame. Particulate desiccant deposited inside the tubular frame elements communicated with air trapped in the IGU interior to remove the entrapped airborne water vapor and thus preclude its condensation within the unit. The frame sides and corners were covered with sealant formed by a hot melt material for securing the frame to the glass lites. The sealant provided a barrier between atmospheric air and the IGU interior which blocked entry of atmospheric water vapor. Thus after the water vapor entrapped in the IGU was removed internal condensation only occurred when the unit failed.

It is known in the prior art to construct an IGU that simulates the appearance of a multipane window. This is accomplished by the inclusion of a muntin bar simulating assembly in the unit. The muntin bar simulating assembly is referred to as a muntin bar assembly for simplicity, but it is not a true muntin bar assembly because the individual four sided muntin bars do not connect and support window panes or lites. A clip for attaching the muntin bar assembly to the IGU frame is disclosed in U.S. Pat. No. 5,313,761 which is incorporated herein by reference.

IGU units are made in different thicknesses for different applications. The thicker the IGU unit, the wider the spacer frame is made to separate the lites a greater distance from each other in the completed IGU. As the width of the spacer frame varies, the clip for holding muntin bar assemblies to the frame also changes. In the prior art, a different clip was fabricated for each frame width.

GED Integrated Solutions, Inc., assignee of the present invention sells a system for making different width spacer frames in a flexible manner that does not require a change of strip material from a source each time a different frame width is desired. In the prior art such flexibility would have required a number of clips on hand so that a specific size clip would be available for each frame width.

### SUMMARY OF THE INVENTION

The disclosure concerns a clip for use with a spacer frame having an elongated channel extending around an inner periphery of the frame. One exemplary clip has a spacer frame engaging body for insertion into a channel of the spacer frame. A flexible body portion flexes from a first configuration to a second configuration as the clip is pushed into the spacer frame to exert an outward force against walls of the spacer frame bounding the frame channel. One clip mounts in different width frames and this is particularly advantageous in use with the spacer frame manufacturing technology that allows rapid change over from one size frame to another without undue delay in moving strip material supply rolls.

The exemplary clip also includes a support body attached to the spacer frame engaging body for supporting structure inside the completed IGU. In one exemplary embodiment, this support body extends inwardly to a region bounded by lites in the completed IGU and engages a muntin bar. In this embodiment the support body has a flexible portion that flexes as the muntin bar is pushed onto the support body to frictionally engage the muntin bar.

The clip can be used with a range of frame widths and hence IGU thicknesses. A maximum width frame is one where there is little or no flexing of the clip occurs as it is inserted into the frame channel. A minimum width frame is one where a maximum amount of flexing is required.

In one exemplary embodiment, a muntin support is attached to a frame engaging body that supports a muntin bar inside a region bounded by the frame. The muntin support includes a center spine that extends from the frame engaging body into the muntin bar and is bound by walls of said muntin bar and a set of first and second elongated fingers coupled to the spine at an angle and having a length to engage side walls of the muntin bar as the spine enters the muntin bar and flexes inward toward said spine to exert a sufficient force against an inner wall surface of said muntin bar. This embodiment allows the use of the clip with different size (width and thickness) as well as different configuration muntin bars such as rectangular and contour muntins.

These and other features of the invention will become more completely understood from the detailed description of multiple alternate embodiments described in conjunction with the accompanying drawings.

### BRIEF DESCRIPTION OF THE DRAWINGS

FIG. 1 is perspective view of an insulating glass unit;

FIG. 2 is a fragmentary plan view of a spacer frame element before the element has had sealant applied and in an unfolded condition;

FIG. 3 is a fragmentary elevational view of the spacer frame element of FIG. 2;

FIG. 4 is a perspective view of one embodiment of a flexible clip for use in conjunction with a spacer frame;

FIG. 4A is a perspective view of an alternate embodiment of a flexible clip;

FIGS. 5, 5A, 5B are additional perspective views of three alternate embodiments of a flexible clip for use with a spacer frame;

FIG. 6 is a side elevation view of the clip of FIGS. 4 and 5;

FIG. 6A is a side elevation view of an alternate clip;

FIG. 7 is a side elevation view showing the clip depicted in FIG. 6 inserted into a muntin bar and attached to a spacer frame;

FIGS. 8-16 and 18 depict alternate embodiments of a clip constructed in accordance with the invention wherein a spacer frame engaging body of the clip comprises a center section coupled to a clip support and outwardly extending flexible side sections;

FIG. 17 is an alternate clip that seats in an adhesive material within a spacer frame channel;

FIGS. 19 and 20 are perspective views of a modified version of the clip depicted in FIGS. 4-6;

FIGS. 21 and 22 illustrate a two piece muntin bar clip;

FIGS. 23-26 show before and after schematic depictions of the use of a muntin bar clip;

FIG. 27 is a top plan view of an alternate clip design showing angled fingers for engaging a muntin bar;

FIGS. 28 and 29 are perspective and plan views illustrating an alternate design for a muntin bar clip;

FIGS. 30-33 depict an alternate clip having different type engagement fingers for use with the present invention; and

FIGS. 34-37 illustrate use of the invention with box type spacer frames.

### DETAILED DESCRIPTION

The Insulating Glass Unit 10

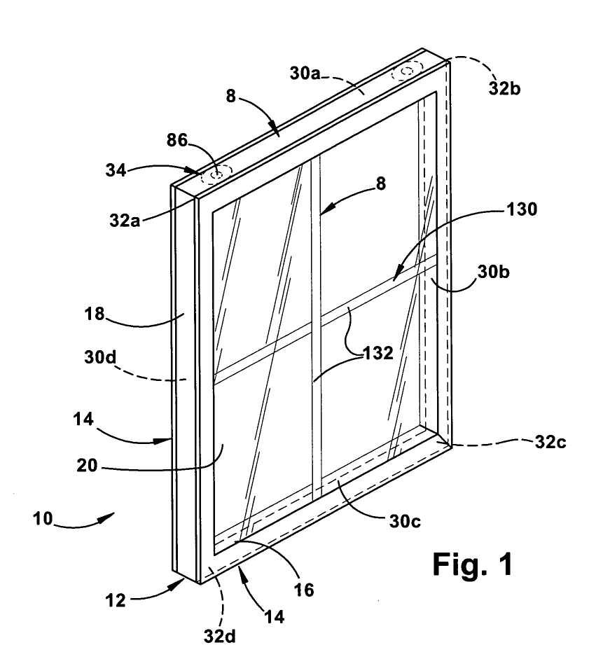

An insulating glass unit (IGU) 10 is illustrated by FIG. 1 as comprising a spacer assembly 12 sandwiched between glass sheets, or lites, 14. The assembly 12 includes a frame structure 16 whose width determines the spacing between lites and therefore the thickness of the IGU. Sealant material (not shown) hermetically joins the frame to the lites to form a closed space 20 within the unit 10 and a desiccant in the space 20. The unit 10 is illustrated in FIG. 1 as in condition for final assembly into a window or door frame (not illustrated) for ultimate installation in a building. The unit 10 illustrated in FIG. 1 includes muntin bars that provide the appearance of individual window panes.

The assembly 12 maintains the lites 14 spaced apart from each other to produce the hermetic insulating “insulating air space” 20 between them. The frame 16 and the sealant body co-act to provide a structure which maintains the lites 14 properly assembled within the space 20 sealed from atmospheric moisture over long time periods during which the unit 10 is subjected to frequent significant thermal stresses. The desiccant removes water vapor from air, or other volatiles, entrapped in the space 20 during construction of the unit 10.

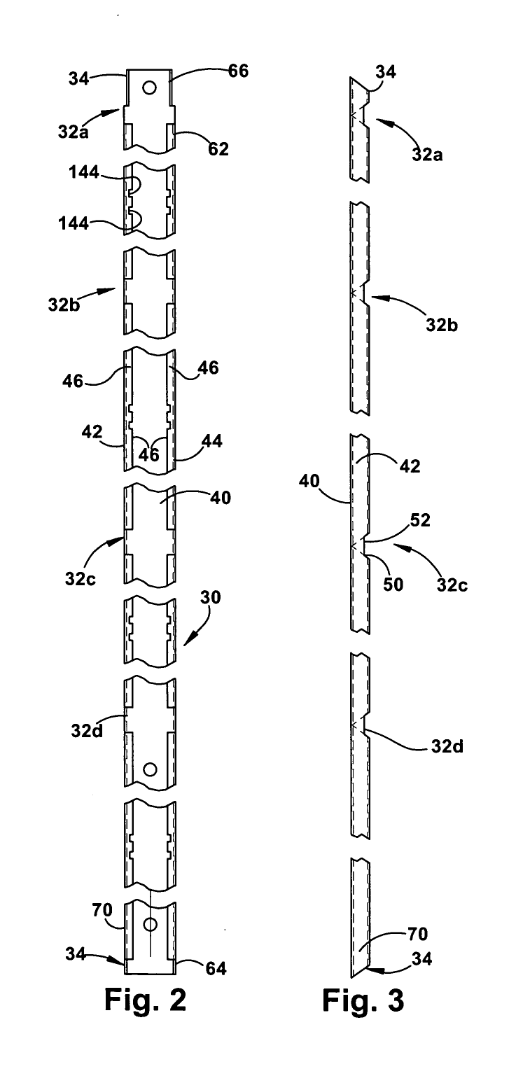

Prior to bending, a frame member 30 (shown in FIGS. 2 and 3) is elongated and has a channel shaped cross section defining a peripheral wall 40 and first and second lateral walls 42, 44. When bent for assembly into an IGU, the frame element has four sides 30a-30d. The peripheral wall 40 extends continuously about the unit 10 except where a connecting structure 34 joins the frame member ends. The lateral walls 42, 44 extend inwardly from the peripheral wall 40 in a direction parallel to the planes of the lites to form a U shaped channel. The illustrated frame 16 has stiffening flanges 46 formed along the inwardly projecting lateral wall edges. The lateral walls 42, 44 add rigidity to the frame member 30 so it resists flexure and bending in a direction transverse to its longitudinal extent. The flanges 46 stiffen the walls 42, 44 so they resist bending and flexure transverse to their longitudinal extents.

The frame is initially formed as a continuous straight channel constructed from a thin ribbon of stainless steel material having a thickness of 0.006-0.010 inches. Other materials, such as galvanized, tin plated steel, aluminum, thermoplastic or vinyl may also be used to construct the frame. Each frame has four corner structures 32a-32d to facilitate bending the frame channel to a final, polygonal frame configuration in the unit 10 while assuring an effective vapor seal at the frame corners. A sealant is applied and adhered to the outside walls 42, 44 of the frame channel before the corners are bent. The corner structures 32a-32d initially comprise notches 50 and weakened zones 52 formed in the walls 42, 44 at frame corner locations. The notches 50 extend into the walls 42, 44 from the respective lateral wall edges. The lateral walls 42, 44 extend continuously along the frame 16 from one end to the other. The walls 42, 44 are weakened at the corner locations because the notches reduce the amount of lateral wall material and eliminate the stiffening flanges 46 and because the walls are stamped to weaken them at the corners.

The connecting structure 34 secures the opposite frame ends 62, 64 together when the frame has been bent to its final configuration. The illustrated connecting structure comprises a connecting tongue structure 66 continuous with and projecting from the frame structure end 62 and a tongue receiving structure 70 at the other frame end 64. The preferred tongue and tongue receiving structures 66, 70 are constructed and sized relative to each other to form a telescopic joint. When assembled, the telescopic joint maintains the frame in its final polygonal configuration prior to assembly of the unit 10.

The unit 10 illustrated in FIG. 1 is constructed to simulate the appearance of a multipane window. This is accomplished by the inclusion of a muntin bar assembly 130 in the unit (FIG. 1). The muntin bar assembly 130 is is typically not a true muntin bar assembly because the individual muntin bars do not connect panes or lites in the windows.

The muntin bar assembly 130 comprises bar members 132 extending across the space 20 between the lights 14, and flexible plastic clips 134 for connecting the bars 132 to the spacer assembly 12. The bars illustrated 132 are formed by elongated metal tubes having generally rectangular cross sectional shapes. Each illustrated bars 132 of FIG. 1 extend between the mid-points of parallel frame members on opposite sides of the IGU through the center of the space 20. The bars 132 are provided with dados at their intersection.

Clip 134

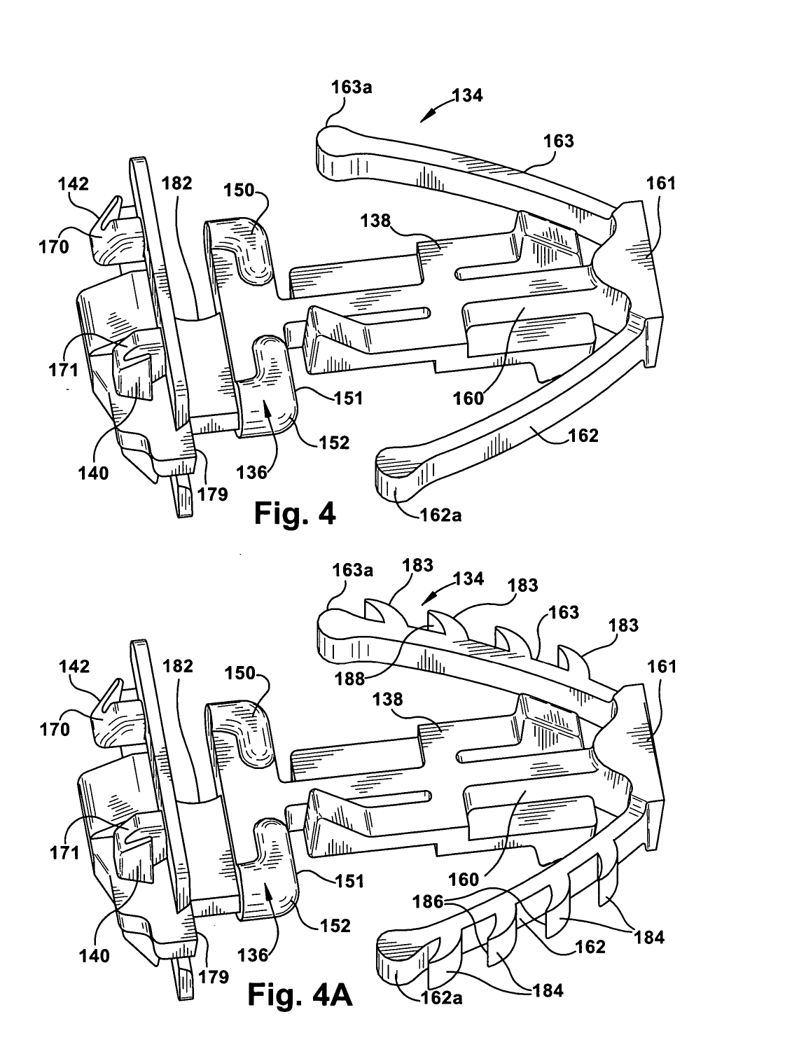

A representative clip 134 shown in FIG. 4 detachably secures the muntin bars 132 to the spacer frame 16. The exemplary clip comprises a center body 136, a bar support 138 projecting in one direction from the body 136, and latches or hooks 140-143 projecting in the opposite direction from the body 136. The latches secure the clip 134 to the spacer frame 16. The clip 134 latches into small rectangular notches 144 (FIG. 2) formed at appropriate locations (four such locations in FIG. 1) in the associated frame wall stiffening flanges 46 with the clip body 136 positioned substantially symmetrically between the spaced apart flanges 46. The notches 144 are relatively shallow and do not extend the full depth (i.e. to the walls 42, 44) of the stiffening flanges 46. Accordingly the frame members are not materially weakened at the notch locations since the flanges 46 remain substantially intact and effective to strengthen the frame member.

The clip body 136 is rectangular (in plan) having L shaped bosses or margins 150-153 at corners facing the bar support 138. The latches or hooks 140-143 project into the channel formed by the frame member while the bar support 138 projects outwardly into the space 20 bound by the IGU.

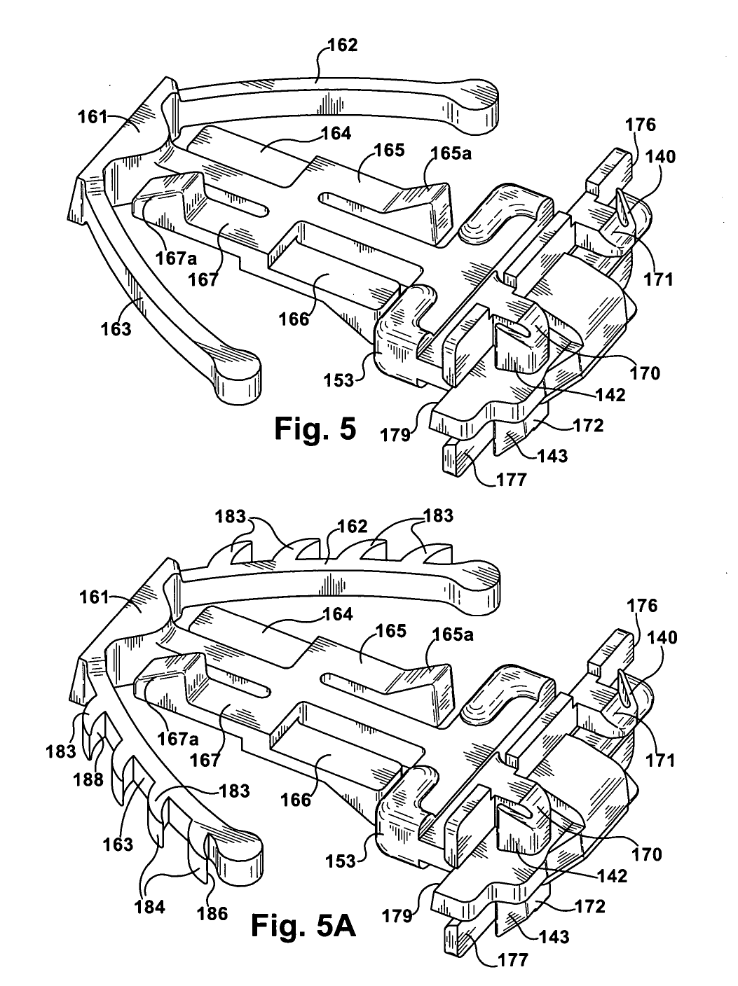

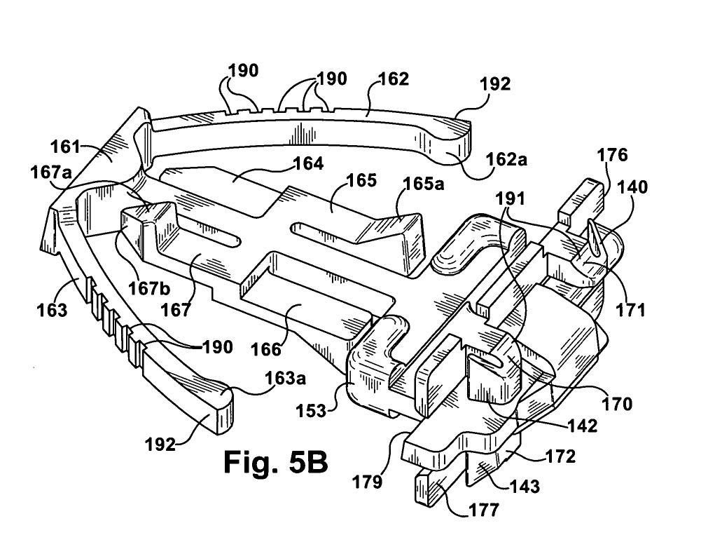

The bar support 138 comprises a center spine 160 integral with the body 136 which widens to an outermost end 161 from which extend two flexible bar retaining fingers 162, 163 having rounded ends 163a, 162a. In an embodiment of FIG. 5B these ends 162a, 163a are flattened on an outside surface of the fingers.

Biasing fingers 164-167 extend longitudinally along opposite sides of the spine 160 and engage inner walls of a muntin bar which is supported by the clip. Each of the biasing fingers have an associated ramp 164a, 165a, 166a, 167a which contacts inner walls of the muntin bar 132 as the clip is inserted into the muntin bar. As the spine is inserted these fingers flex slightly to exert a retaining force against the muntin bar.

Each latch or hook 140-143 projects from an associated latch body 170, 171, 172 173 integral with one of two platforms 176, 177 spaced on opposite sides of the clip within the spacer frame channel. These platforms or pontoons 176, 177 abut outer surfaces of the stiffening flanges 46 of the spacer frame 16. A U or wedge shaped support 180 that flexes as the clip is inserted into the channel is attached at a center to a bottom stem 182 that extends downward from the body 136. Two side arms 180a, 180b of the wedge shaped support 180 are attached to the platforms 176, 177. Each latch hook is resiliently deflectable toward and away from its associated latch body. The latch body is formed with a wedge face or surface 191 on its outwardly facing side which facilitates inserting the clip into the receiving flange notch 144. The hook is resiliently deflected toward its associated latch body by the flange notch edge as the clip is inserted into the frame member. When the hook clears the notch edge the hook snaps back to its undeflected position and traps the flange 46 between the latch or hook and its associated latch body.

Operation of FIGS. 4 and 5 Embodiments

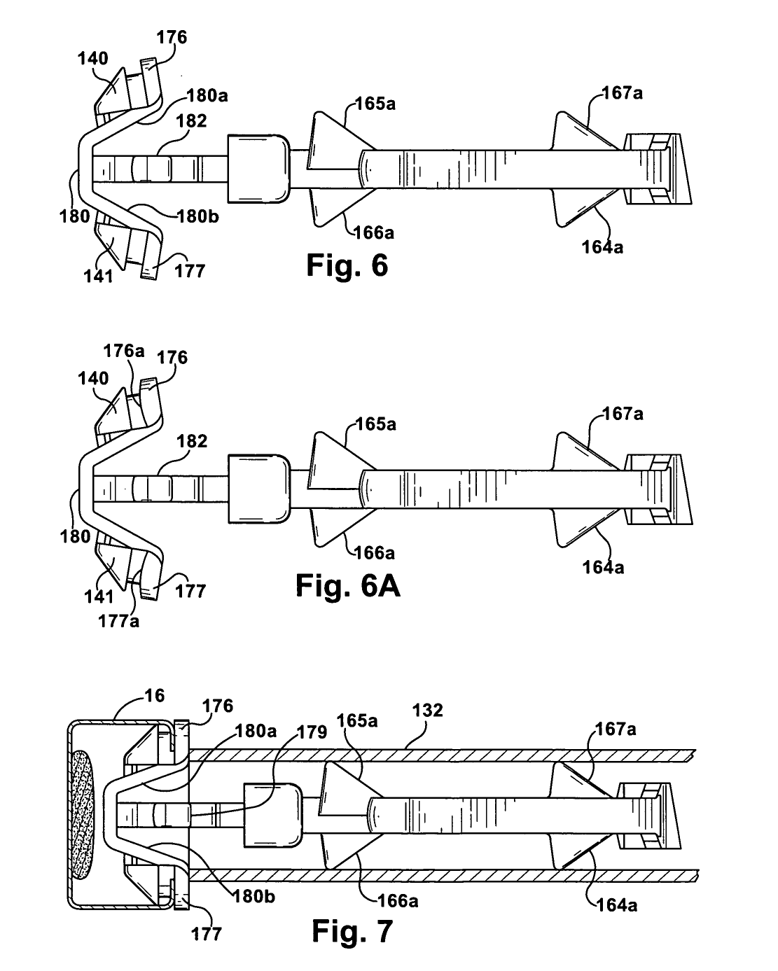

As the unit is assembled, the muntin engaging end of the clip is slid into one end of the muntin bar 132. The clips are inserted into the muntin bars first and then into the spacer frame. The clip is attached to the spacer frame by flexing the wedge shaped support 180 inwardly until the hooks can be forced through the notches 144 in the frame. The clip can be used with a range of different width channels for different thickness IGUs. A maximum width channel is one where there is little or no flexing of the clip as it's hooks are inserted into the notches 144. In that use, the installed clip resembles the clip shown in FIG. 6. For narrower frames the side arms 180a, 180b are flexed inwardly toward each other as the clip is inserted into an entrance to the frame channel defined by the spacer frame flange. A minimum width frame is one where the two platforms 176, 177 almost contact the narrow center stem 182 as the clip is flexed to force the hooks through the notches 144. As noted above, the hooks are flexed inward as the clip is inserted into the channel until the prongs at the end of the hooks pass by the edge of the notches and spring back into place thereby trapping the clip to the frame. The engagement between clip and frame is made more secure by the outward force exerted by the compressed support arms 180a, 180b which tends to keep the hooks from disengaging from the flange 46. FIGS. 6 and 7 depict before and after views of the clip. As the other end of the clip is slipped into the muntin bar, the fingers 162, 163 bend inward toward the center spine 160. These fingers frictionally engage the more narrow inner walls of the muntin bar. Similarly, the ramps 164a, 165a, 166a, 167a of the clip contact the wider inner walls of the muntin bar and act as a lead during insertion of the clip into the muntin bar. The end of travel for the four sided bar 132 is defined by stops 179 that extend outwardly beyond the extent of the body 136 and having generally planar surfaces that are contacted by the end of the muntin bar in a region that is generally co-planar with the region orthogonal sides of the muntin bar engage the platforms 176, 177 (See FIG. 7). In viewing FIG. 7, if the clip 134 is used in a wider spacer frame, the platforms will fit on top of the frame's flange but not be contacted by the bottom edge of the muntin bar. Stated another way, the unflexed configuration of the clip 134 orients the platforms at a spacing greater than the width of the muntin bar in that dimension.

FIG. 6A shows an alternate clip. A feature of the clip of FIG. 6 is that the platforms 176, 177 do not lie flat against the frame stiffening flange except for an intermediate width spacer frame. Use of a convex underside 176a, 177a to the hook platform achieves a rolling contact point between the frame flange and the platform.

The clip can be used with a range of frame widths and hence IGU thicknesses. A maximum width frame is one where there is little or no flexing of the clip occurs as it is inserted into the frame channel. A minimum width frame is one where a maximum amount of flexing is required. Typical ranges for the frame widths for use with the present invention are from 5/16 to ⅞ inches with approximately 20 different widths in equal increments of 1/32 inch in between these maximum and minimums widths. Each of the clips can be inserted into at least 3 or 4 different width spacer frames.

FIGS. 4A, 5A and 5B depict a clip 134 wherein the fingers 162, 163 that engage the muntin bar 132 have been modified to enhance the holding or gripping engagement between the clip 134 and the muntin bar 132. In the depiction of FIGS. 4A and 5A, a series of hooks 183 are added to the outer surface of the fingers 162, 163. These hooks 183 have convex outer surfaces 184 that engage the interior of the muntin bar and slide along the surface of the muntin bar with relatively low friction resistance as the clip is slid into the muntin bar. Once in the bar, however, a sharp pointed vertex 186 of the hook tends to impede withdrawl of the clip from the muntin bar. This vertex is created at a region where the convex outer surface 184 of the hook meets an inner, concave hook surface 188 that defines a backside surface of the hook.

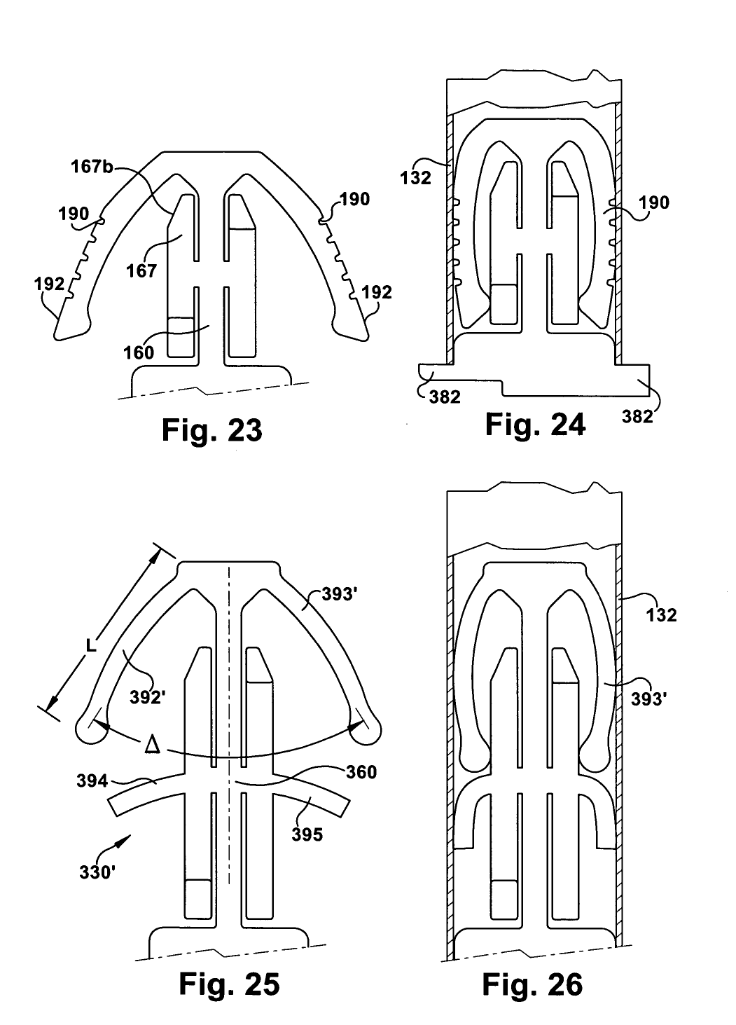

In FIG. 5B another alternate embodiment for the fingers 162, 163 is disclosed. This design includes a series of slots 190 along a region of the outer surface of the fingers. These slots are generally rectangular in plan having a depth slightly less than their width and a length extending across an outer surface of the fingers 162, 163. Engagement with these slots also impedes withdrawal of the clip from the muntin bar once it has been inserted into the bar. In this embodiment the ends 162a, 163a have flattened outer surfaces 192 which engage the inside of the muntin bars. The clip of FIG. 5B is schematically depicted in FIG. 23 before it is inserted into a muntin bar 132. In addition to the ramps such as the ramp 167a shown in FIG. 5B, the fingers of this embodiment are tapered along a surface 167b for example, to allow clearance between inner walls of the fingers 162, 163 and the the fingers 164-167 with the clip in the collapsed state after it has been inserted into the muntin bar, See FIG. 24.

### ALTERNATE EMBODIMENTS

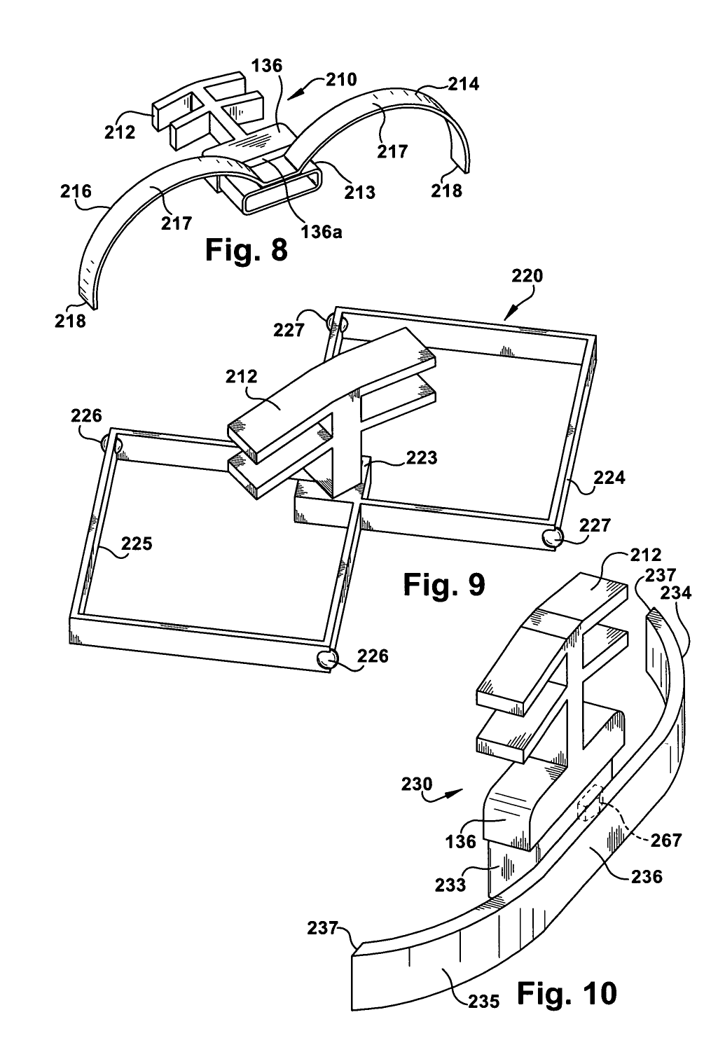

FIGS. 8-17 depict alternate embodiments of a single piece plastic molded clip which in the preferred embodiment is made from nylon having a small percentage of glass filler material. Each of these embodiments includes a spacer frame engaging body for insertion into a channel of the spacer frame and including a flexible body portion which flexes from a first configuration to a second configuration as the clip is pushed into the spacer frame to exert an outward force against walls of the spacer frame bounding the frame channel. Each clip in these figures has a muntin bar engaging body 212 (illustrated schematically) and support body 136 attached to the spacer frame engaging body which includes a flexible portion that flexes as the muntin bar engaging body is pushed into the muntin bar.

The clip 210 of FIG. 8 has a spacer frame engaging body having a center section 213 that fits into the channel of the spacer frame. Two flexible bands 214, 216 are attached to the center section. A curved center section 217 of the band engages one interior side of the spacer frame and a distal end 218 of each of the bands engages an opposite side of the spacer frame's interior wall. A width of the bands 214, 216 is such that once the bands are inserted into the spacer frame channel, the flanges 46 of the spacer frame engage one edge of the bands and a second edge engages an inwardly facing wall of the spacer frame. Additionally, a clip body 136 overlies a segment of the flange securing the clip by trapping the flange between a flat surface 136a of the body and curved proximal portions of the two bands 214, 216.

The clip 220 of FIG. 9 has a spacer frame engaging body having a center section 223 coupled to the muntin bar engaging body 212 and outwardly extending flexible side sections defined by two interconnected polygons 224, 225 (depicted as four sided). Vertices of the polygons flex inward for insertion into a spacer frame channel. Each polygon has outwardly extending contact portions 226, 227 which engage opposite sides of the spacer frame channel and thereby maintain the clip in engagement with the spacer frame. The contact portions 226, 227 may be used in conjunction with locating indentations (not shown) along the side wall of the spacer frame in which the convex portions 226, 227 would seat that would perform the task of the notches 144 of FIG. 2. The width of these polygons is chosen to fit within the spacer frame channel beneath the flange 46.

The clip 230 of FIG. 10 has a spacer frame engaging body having a center section 233 that supports two outwardly extending flexible side bands 234, 235 having two generally straight sections 236 attached to the center section 233 and curved distal ends 237 that contact an opposite side of the spacer frame channel. The two bands are constructed from flexible material so that they can be flexed a sufficient amount to fit into the channel and then return to a configuration that spans a width of a spacer frame channel and traps the flange of the spacer frame between the straight, center section 236 and the body 136. An optional locating tab 267 could also be used to locate the clip 230 along the extent of the spacer frame by fitting into an appropriately sized notch in the flange of the frame.

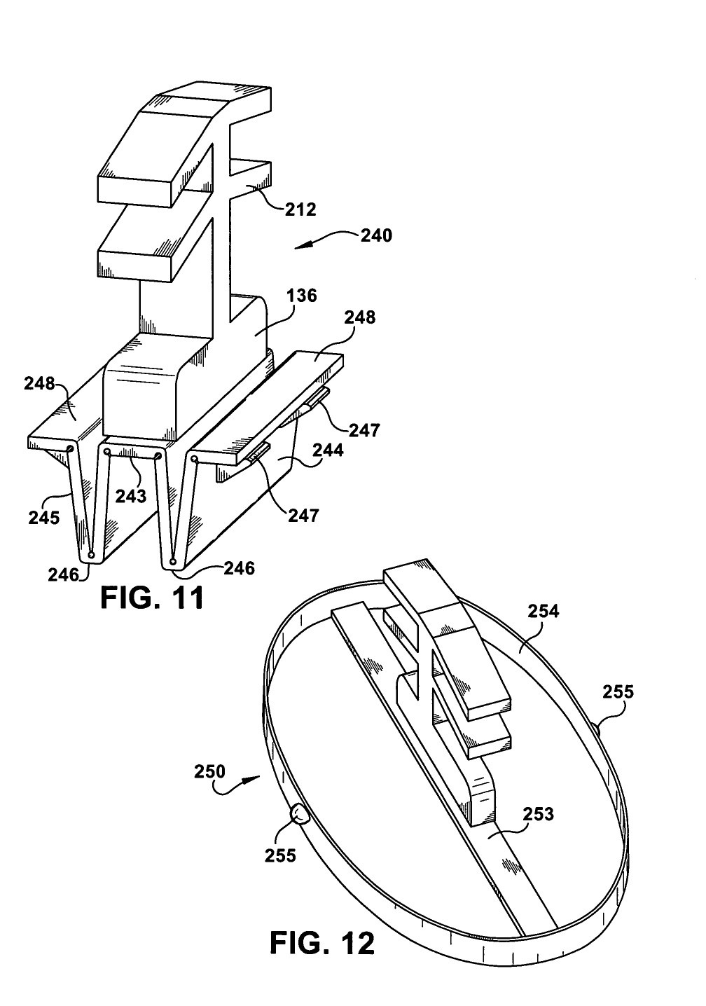

The clip 240 of FIG. 11 has a spacer frame engaging body having a center section 243 coupled to outwardly extending flexible side sections that are made up of first and second flexible wedge shaped portions 244, 245 having vertices 246 that flex inwardly as they are inserted into a spacer channel. This embodiment includes flexible fingers 247 attached to platforms 248 similar to the platforms 177 of the FIG. 4 embodiment. The intersection of the platform 248 and the sidewalls of the wedge shaped portion 245 as well as the vertex 246 are formed by living hinge relief joints that allow the clip to flex to different configurations depending on the width of the spacer frame.

The clip 250 of FIG. 12 has a center section 253 in the form of a beam wherein the outwardly extending flexible side sections comprise an oval shaped member 254 that spans a width of a spacer channel. On an outwardly facing surface of the oval shaped member this clip includes ball shaped contacts 255 that engage inwardly facing walls of the spacer frame channel. This inwardly facing wall may include a necked out location (or cutout) on the wall for receipt of the contact 255 to position the clip 250 along the frames side wall. A cut out can be used in the frame wall since this part of the spacer frame wall is covered with an sealing adhesive during assembly of the IGU and hence a hermetic seal is maintained. These contacts are diametrically opposite each other spaced apart across a minor axis of the oval shaped member 254. The width of the oval member is such that it fits between a space between the flange of the spacer frame and the back wall of the frame.

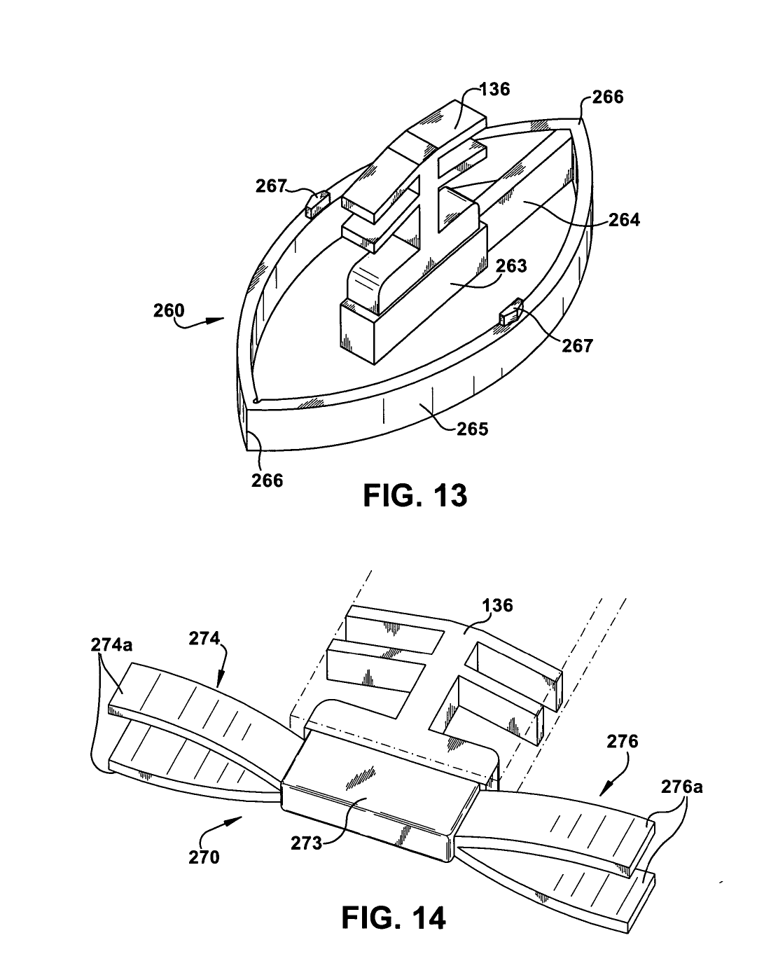

The clip 260 of FIG. 13 has a center section 263 coupled to a beam 264 that connects an oval shaped flexible member 265 to the center section 263. Ends of the oval shaped member 265 form vertices 266 in a region generally centered within the spacer frame. The width of the oval shaped member 265 is such that it fits between a space between the flange of the spacer frame and the back wall of the frame. Two bosses 267 along one edge of the oval shaped member fit within appropriately sized notches such as the notches 144 to fix the clip 260 longitudinally within the spacer frame.

The clip 270 of FIG. 14 has a center section 273 and outwardly extending flexible side sections that include first and second sets 274, 276 of deflectable fingers having distal portion's 274a, 276a that engage side walls of a spacer frame channel. The distal ends are flexed toward each other to fit within the spacer frame channel and then free to flex back into contact with the inside walls of the frame. A width of the fingers is such that the clip fingers are trapped between the flange and the wall of the spacer.

The clip 280 of FIG. 15 has a center section 283 coupled to a muntin bar engaging boss 136. the center section 283 is coupled to an oval shaped member 285 similar to the member 265 of FIG. 13. The center section 283 is offset to the side of the spacer frame channel and connected to an elongated side of the oval shaped member 285. Bosses 286, 287 connected to the oval shaped member 285 position the clip 280 along the extent of the spacer frame by fitting into appropriately sized notches in the frame flange.

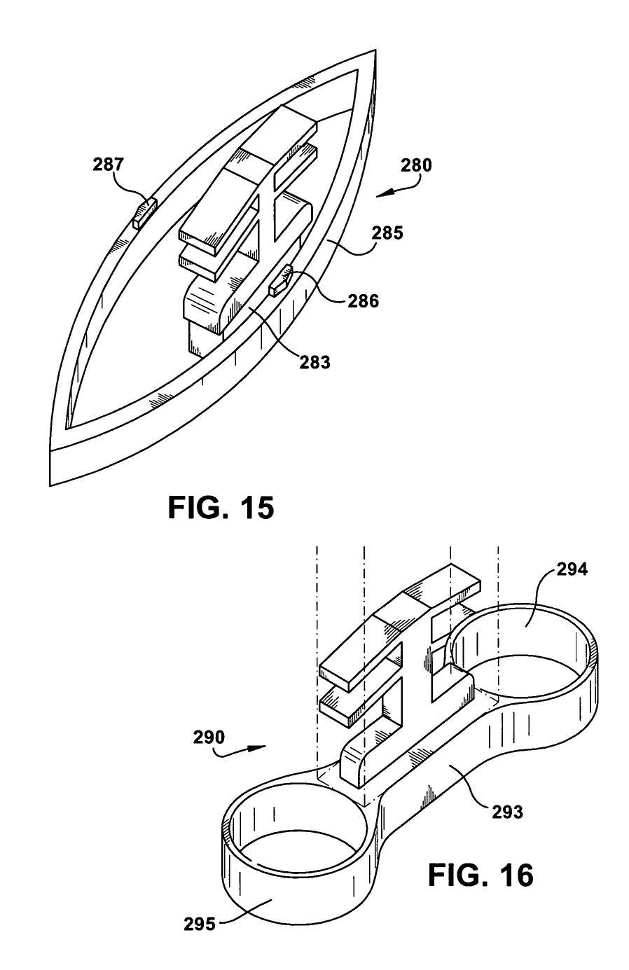

The clip 290 of FIG. 16 has a center section 293 and outwardly extending flexible side lobes 294, 295 that are flexed inwardly to fit into the channel of said spacer frame and then flex outwardly to secure said clip to the spacer frame. The width of the lobes is chosen such that the lobes fit within a region between the spacer frame flange and a bottom wall of the channel.

The clip 300 of FIG. 18 has a center section 303 coupled to outwardly extending flexible side sections which include two flexible leg 304, 305 having multiple bends along their length. The bends 306 of each of the legs connect two generally flat portions 307, 308 configured to contact inner facing surfaces of the spacer frame channel. Bosses 267 or nipples 267a engage suitable notches in the flange or depressions formed in the side walls of the frame.

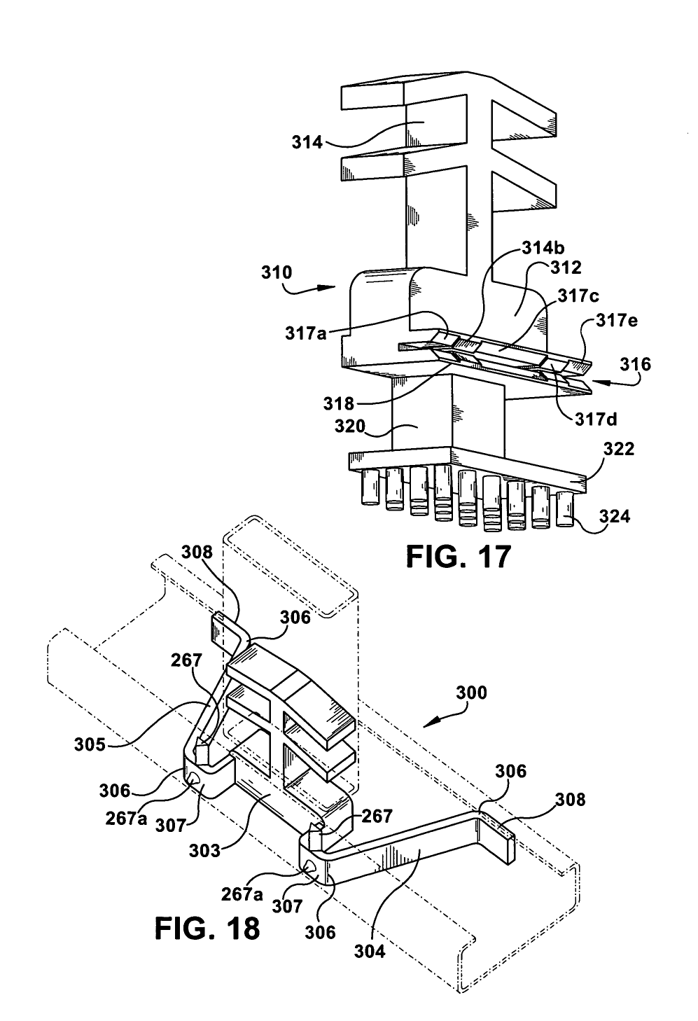

The clip 310 of FIG. 17 includes a center body portion 312 from which extends a muntin bar engaging portion 314. The center body portion defines a notch 316 bounded by first and second sets of flexible fingers 317, 318. The fingers 317a-317e of a first set 317 are segmented and flex independently of each other. During assembly, the clip 310 is inserted into the spacer frame and the fingers spread apart as they are pushed over one flange of the side walls of the spacer frame. The finger engagement is a press fit into the spacer flange and the fingers 317b, 317d act as positioning locators and prevent side to side motion of the clip 310 with respect to the spacer frame. As the clip is position over the flange the fingers 317b, 317d fit into the slots 144 of the flange as the adjacent fingers 317a, 317c, 317e flex to fit over the flange.

The clip 310 also includes a post 320 which extends into the spacer frame and supports a platform 322 having a number of inward extending feet 324 which engage a dessicant material within the spacer frame anchoring the clip to the spacer using the dessicated butyl as an adhesive.

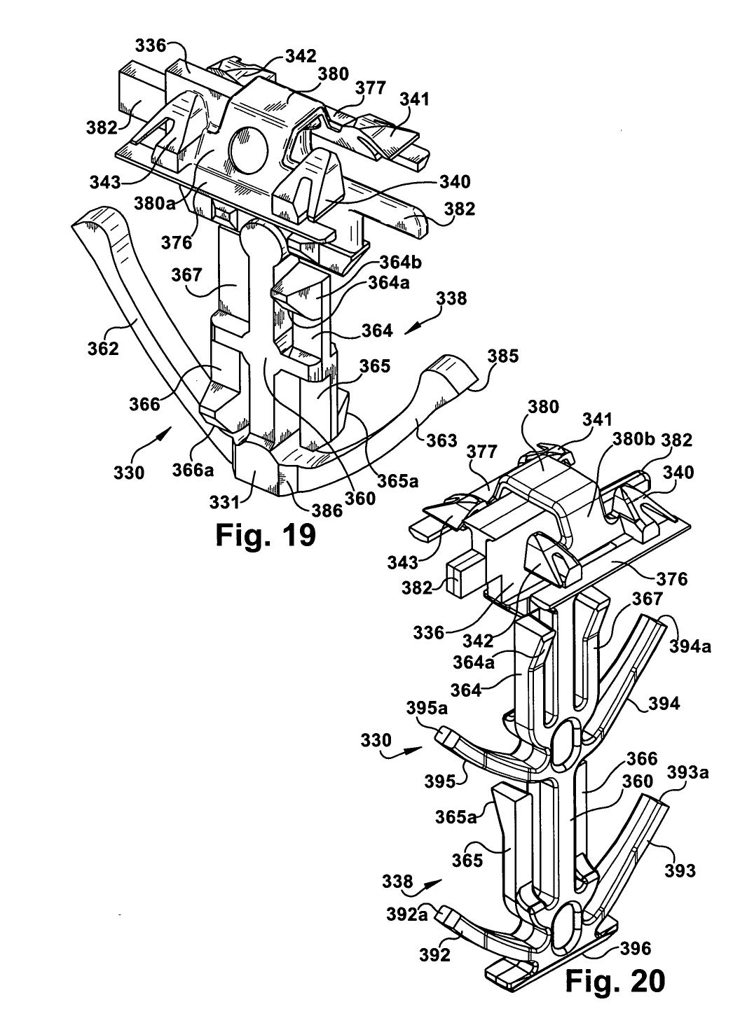

Two additional alternate clips 330 shown in FIGS. 19 and 20 detachably secures the muntin bars to a spacer frame 16. The clips 330 of those figures comprises a center body 336, a bar support 338 projecting in one direction from the body 336, and latches or hooks 340-343 located to the side of the body 336. The latches secure the clip 330 to the spacer frame 16. The latches 340-343 fit into small rectangular notches 144 (FIG. 2) formed at appropriate locations (four such locations in FIG. 1) in the associated frame wall

The latches or hooks 340-343 project into the channel formed by the frame member while the bar support 138 projects outwardly in an opposite direction. The bar support 338 comprises a center spine 360 integral with the body 336 which widens to an outermost or proximal end 131 from which extend two flexible bar retaining fingers 362, 363 extend from this spine in FIG. 19. The ends of the two fingers 362, 363 have flattened surfaces 385 at their distal ends removed from the spine. Except for a region 386 of enlargement where the fingers meet the spine, the fingers 362, 363 are generally uniform in cross section along their length. This like the other embodiments is molded so that the fingers and spine are integral with each other.

Biasing fingers 364-367 extend longitudinally along opposite sides of the spine 360 and engage inner walls of a muntin bar which is supported by the clip. Each of the biasing fingers have an associated ramp 364a, 365a, 366a, 367a which contact inner walls of the muntin bar 132 as the clip is inserted into the muntin bar. As in the FIG. 5B embodiment discussed previously, this set of fingers 364-367 has beveled or ramps on the side such as the ramp 364b.

Each latch or hook 340-343 projects from an associated latch body which extend away from one of two platforms 376, 377 spaced on opposite sides of the clip within the spacer frame channel. These platforms 376, 377 abut the stiffening flanges 46 of the spacer frame. A U or wedge shaped support 380 that flexes as the clip is inserted into the channel. Two side arms 380a, 380b of the wedge shaped support 180 are attached to the platforms 376, 377. Each latch hook is resiliently deflectable toward and away from its associated latch body. The latch body is formed with a wedge face or surface on its outwardly facing side which facilitates inserting the clip into the receiving flange notch. The hook is resiliently deflected toward its associated latch body by the flange notch edge as the clip is inserted into the frame member. When the hook clears the notch edge the hook snaps back to its undeflected position and traps the flange 46 between the latch or hook and its associated latch body.

The embodiment of FIG. 19 includes two muntin bar stops 382 extending on either side of the body 336. These stops 382 define the final end position of the muntin bars as they are pushed onto the bar support 338. These stops perform the function of the flat surfaces of the stops 179 shown in the FIGS. 4 and 5 clip depictions.

The FIG. 20 embodiment differs from FIG. 19 in that it has four outwardly extending fingers, one set of fingers 392, 393 extend from a distal most end of the spine 360 and a second set of fingers 394, 395 extend from the spine 360 at approximately a midpoint of the spine. An additional difference is that at the end of the spine the clip 330 widens to a flat top hat portion 396. The top hat portion 396 has a flat end that faces the muntin bar end and acts as a centering lead for installation of the muntin bar to help keep the clip straight as it enters the muntin bar. On smaller muntin bars this top hat will act as an anti-twist device. Note, the fingers 392-395 are wider at their base in a region of the center spine and then taper as they extend outwardly which helps keep the fingers from twisting or bending as they are inserted. The thin finger at the distal end tends to bend more easily as it is initially displaced but the thicker proximal end resists bending the more the distal end is displaced. Additionally, the fingers 392-395 have truncated distal ends 392a-395a that are not enlarged. Note, the ramps 364a-367a are arranged so that the ramps from adjacent fingers 364, 367 (for example) extend outwardly toward the inner wall of the muntin bar in the same general configuration whereas in FIG. 19 the ramps of adjacent fingers contact opposite muntin bar walls.

Before and after depictions of a clip 330′ similar to the FIG. 20 clip are shown schematically in FIGS. 25 and 26. This clip 330′ has enlarged distal ends for the two fingers 392′, 393′ rather than the simply truncated ends of the fingers shown in FIG. 20.

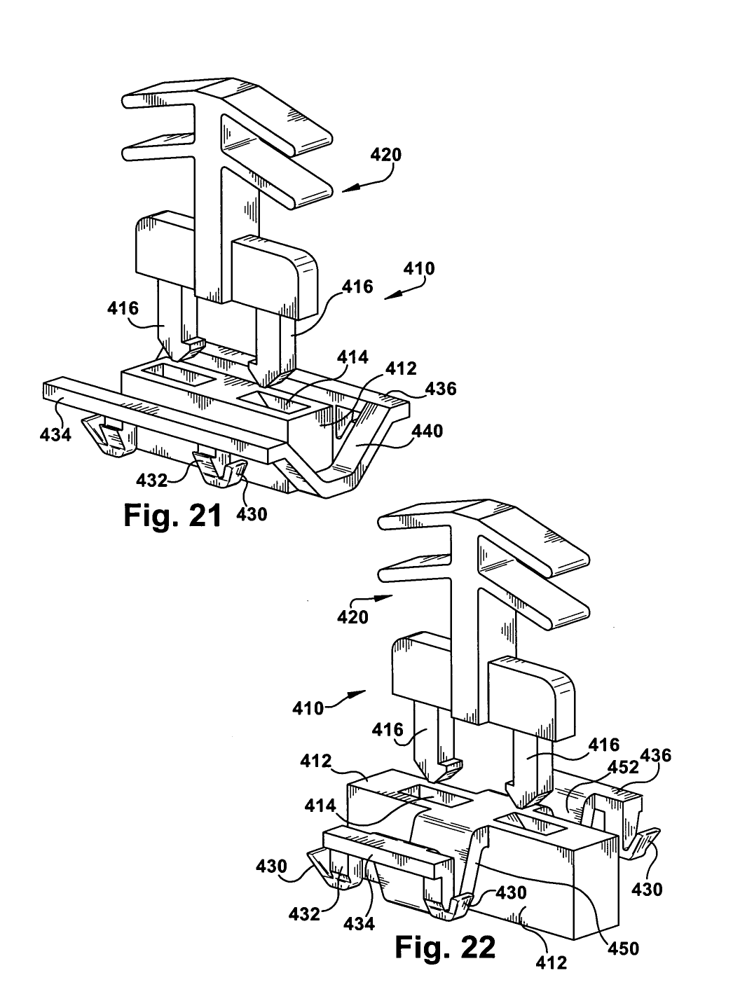

FIGS. 21 and 22 illustrate a two piece clip 410 that includes a base 412 that includes notches 414 for receipt of corresponding latching connectors 416 that are attached to a bar support 420. Latches or hooks 430 project from an associated latch body 432 which extends away from one of two platforms 434, 436 spaced on opposite sides of the clip within the spacer frame channel. These platforms abut the stiffening flanges 46 of the spacer frame. A U or wedge shaped support flexes as the clip is inserted into the spacer frame channel.

In the FIG. 21 embodiment, two U shaped side arms 440 (only one of which is visible in the figure) are attached to an end portion of the base 412 and extend outwardly similar to outriggers on a boat to the platforms 434, 436. As the clip is inserted into the spacer frame, these arms flex to decrease the width of the clip to allow it to fit into the spacer frame channel. The hooks 430 engage appropriately spaced slots in the frame's flange as described previously.

In the FIG. 22 embodiment, there are two V shaped arms 450, 452 which attach to the base 412. These arms extend from side portions of the base and bend more steeply in the direction of the frame channel (in an orientation of insertion) and then reach a valley vertex region of the V and bend back along an elongated portion that engages the platforms 434, 436. As seen in the figure from an end view the two arms form a W shape with an elongated center portion formed by the base 412 of the clip.

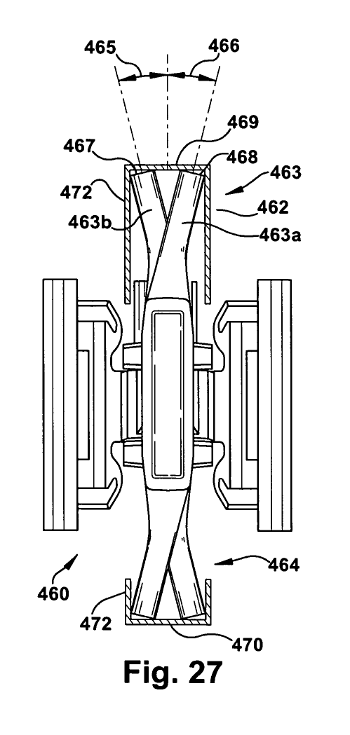

FIG. 27 depicts a clip 460 that is designed to engage a muntin bar and maintain an alignment of the bar engaging portion of the clip and resist twisting or bending of the clip with respect to a muntin bar. The FIG. 27 clip has a center spine attached to a spacer frame engaging body and that extends away from said spacer frame engaging body into a muntin bar 462. Pairs of elonogated flexible fingers 463, 464 extend longitudinally along opposite sides of the spine and also extend outwardly from the spine at angles 465, 466 to contact an inner wall of the muntin bar at spaced locations 467, 468 on oppositely spaced first and second walls 469, 470 of the muntin bar to frictionally engage and align said muntin bar with respect to the spacer frame.

The disclosed clip 460 has fingers 463a, 463b that extend from a side of the spine form a subtended angle (angle 465+angle 466) of between 10 and 20 degrees. A most preferable subtended angle between the fingers of a set is approximately 14 degrees. Stated another way, a most preferred angle between the fingers and a centerline such as the angle 465 is one half the total subtended angle or 7 degrees. The fingers are of a length and are bent at such an angle that they engage both side 472 and end walls 470 of the muntin bar simultaneously.

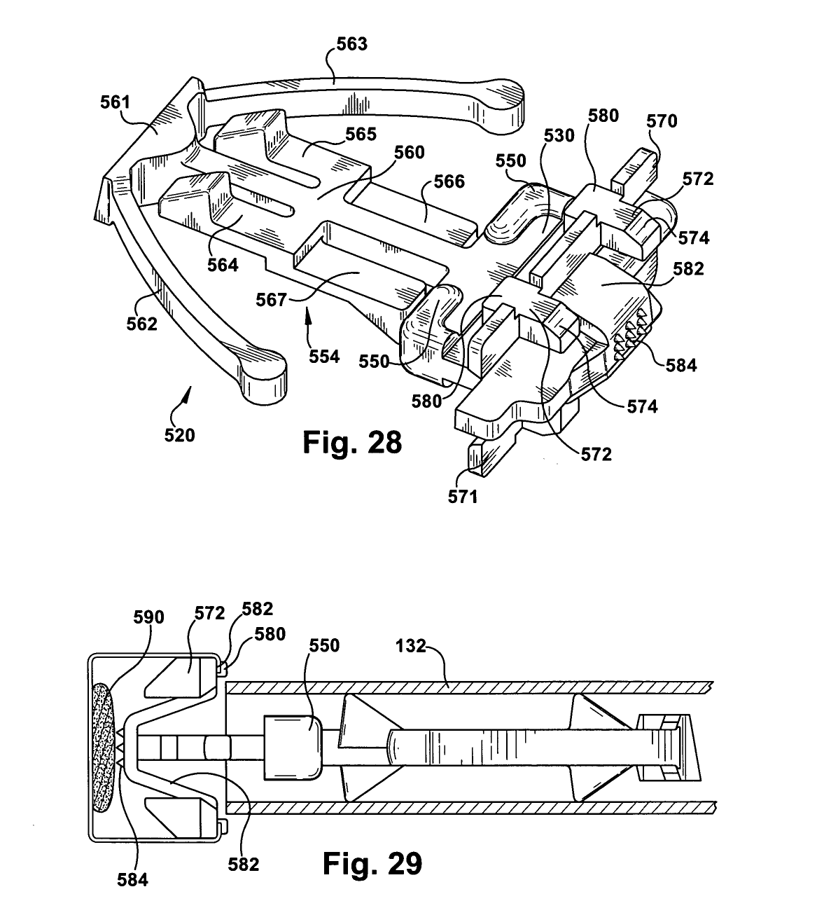

FIGS. 28 and 29 show an additional alternate embodiment of a clip 520 constructed in accordance with the invention. A clip body 530 is rectangular (in plan) having L shaped bosses or margins 550 at corners facing a bar support 554. As described more fully below, no latches or hooks project into the channel formed by the frame member while the bar support 554 projects outwardly into the space 20.

The bar support 554 comprises a center spine 560 integral with the clip body 530 which widens to an outermost end 561 from which extend two flexible bar retaining fingers 562, 563 having ends having generally flat outwardly facing contact surfaces or regions for engaging, for example, a muntin bar. Biasing fingers 564-567 extend longitudinally along opposite sides of the spine 460 and engage inner walls of a muntin bar which is supported by the clip. Each of the biasing fingers have an associated ramp which contacts inner walls of the muntin bar 132 as the clip is inserted into the muntin bar.

The clip body 530 narrows to a center body that extends away from the muntin bar support portion of the clip. The center body extends to a region of a generally U shaped member 582 having arms that flair outwardly toward either side to a region of the flange of the spacer frame. This U shaped member 582 has an unflexed configuration allowing the clip to be used for a widest spacer frame of a range of such widths and a compressed or flexed configuration where the clip is used for narrower spacer frames. As stated above, a typical clip can be used for a range of from three to four such spacer frame widths assuming a separation of 1/32 inch between adjacent frame widths. At distal ends of the U shaped member 582 are located two platforms 570 having surfaces 583 which rest against the spacer frame flange 46 (See FIG. 29) once the clip is inserted into the frame.

Locating posts 572 integral with the platforms include a portion 580 that extends through the flange 46 and more particularly extend through the locating notches 144 in the flange. The posts 572 are elongated or oblong in shape and are generally rectangular in plan as seen from the end of the clip at the region of the muntin bar engagement. The width of the post is chosen to fit through but frictionally engage the side of the notches once the clip is installed in the spacer frame. The posts 572 include a beveled portion 574 that facilitates insertion of the clip into the spacer frame.

As seen in FIG. 29 a generally convex surface of the U shaped member 582 that faces inner walls of the spacer frame includes a regular pattern of teeth 584 arranged in rows that extend a short distance (approx 0.06 inches) from the surface of the U shaped member 582. These teeth sink into a dessicant material 590 within the frame and help secure the clip 520 in place.

A function of the side branches or fingers 362, 363, 392, 393 is to accommodate different size muntin bars. The two or more fingers are thinner, longer and more flexible than prior art muntin bar engaging fingers. The flexibility is achieved by utilizing a longer bending moment that originates from the top of the spine and extends to the longer tips of the longer fingers. This is analogous to a fishing rod that bends easily in longer lengths than a shorter rod that is flexible. The important criteria is that different dimension muntin bars are frictionally engaged with sufficient force for different amounts of bending. Exemplary dimension of 0.67 inch for the length L of the finger 392′ shown in FIG. 25 is 0.67 inches and the angle Δ between or subtended by the fingers is 110 degrees. In the illustrated embodiment the generally rectangular cross section finger at the region of the distal tip is approximately 0.07 inch long by 0.05 inch wide (and fall in a range of 0.07 to 0.10 by 0.04 to 0.06 inches). They are also oriented with respect to the center spine of the support at a more severe angle than the prior art wherein the fingers extend outwardly at generally perpendicular angles from a spine. In the exemplary embodiment the angle the fingers make with the spine which extends into the muntin bar is generally in a range of from 55 to 65 degrees. The arrowhead shape of the fingers acts as a lead during insertion into the muntin bar. The more flexible fingers have a wider span from finger tip to finger tip allowing these fingers to maintain contact with the inner Side walls of the muntin bar that extend away from the spacer frame at right angles to the plane of the spacer frame. The flexibility and length of the fingers allow the tree portion of the clip to flex through a range of muntin bar widths and still maintain positive contact.

The torsion bars with tapered ramps 164-167 are designed to accommodate different width muntin bars. They adjust to the muntin bar width by applying equal and opposite pressures to the side walls of the muntin bar.

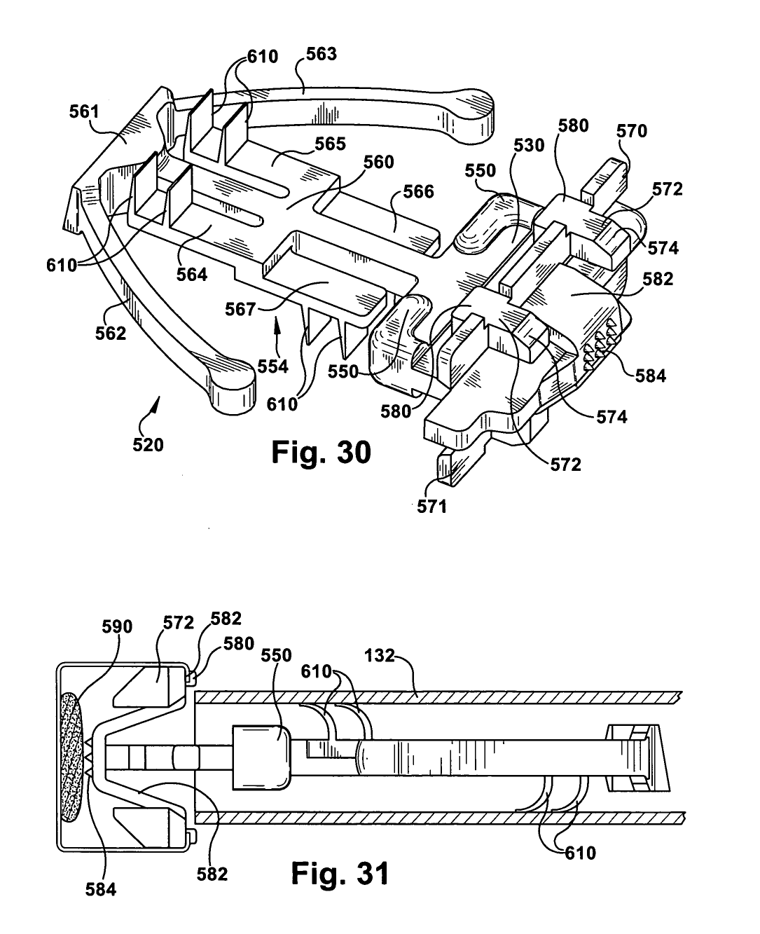

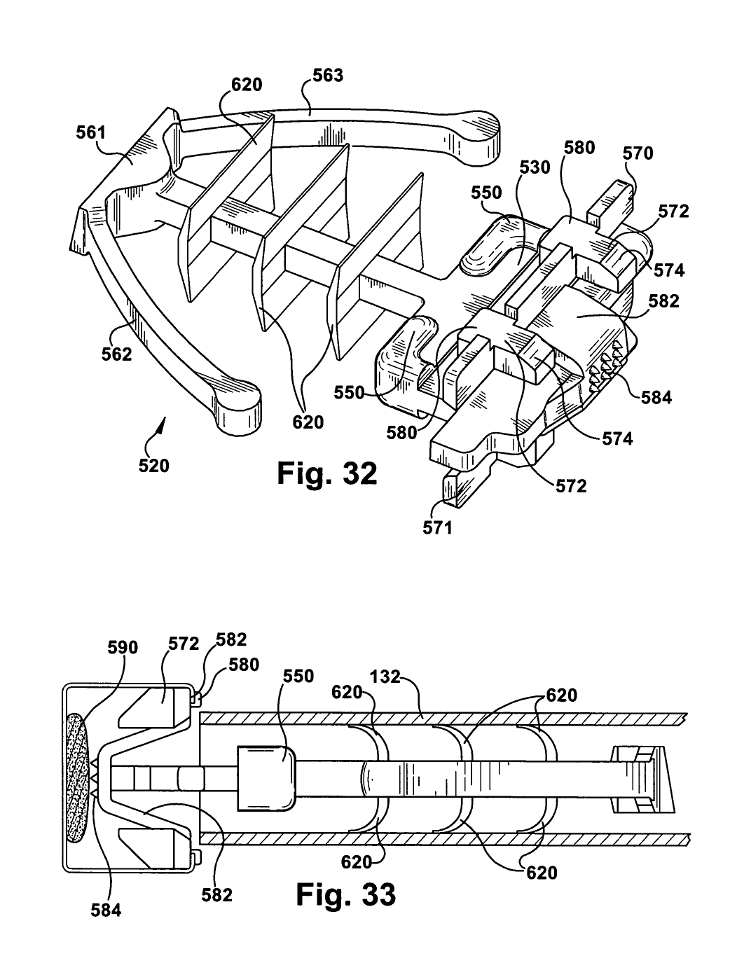

The torsion bar ramps 164a-167a can be replaced by flexible, thinner longer feeler ramps that will flex to the inner width of the muntin bar walls. This design will allow contact with wider style muntin bars. In FIGS. 30-33 the torsion bars are replaced with thin wipers 610, 620 which ride on the side walls of the muntin bar cavity. The wipers will flex as needed to maintain holding pressure and center the clip. The wipers can be used with either 2 or 4 finger designs. In the embodiment of FIG. 30 the wipers 610 extend at roughly right angles to the fingers 564-567. They are thicker near a base region where the engage the fingers and narrow outwardly to ends that are relatively thin and form a sharp v where they engage the muntin bars. The wipers are flexible enough to be used with different dimension (thickness) muntin bars. The wipers 620 shown in FIG. 32 are arcuate

As seen in the figures the finger design may have a series of hooks 183 or ridges 190 on the outside surface of the fingers, to help grab inner side walls of different design muntin bars such as contour muntin bars. A rough texture on the outside surface of the fingers will also help impede withdrawl of the clip. This roughened surface increases the coefficient of friction between the muntin bar's inner wall and the clip fingers.

In its unflexed state, the clip has a profile that will hold into a larger cavity muntin bar. In its collapsed state the clip tree can flex to a smaller state to hold onto smaller profile muntin bars without exerting excess pressure that would cause unwanted deformities to the muntin bar. The range of a possible states of the fingers is seen by reference to FIGS. 23 and 24 which illustrate an uncompressed state (FIG. 23) and fully compressed state (FIG. 24) The clip could engage muntin bars only slightly narrower than the span of the fingers to a much narrower muntin bar such as the bar 132 in FIG. 24.

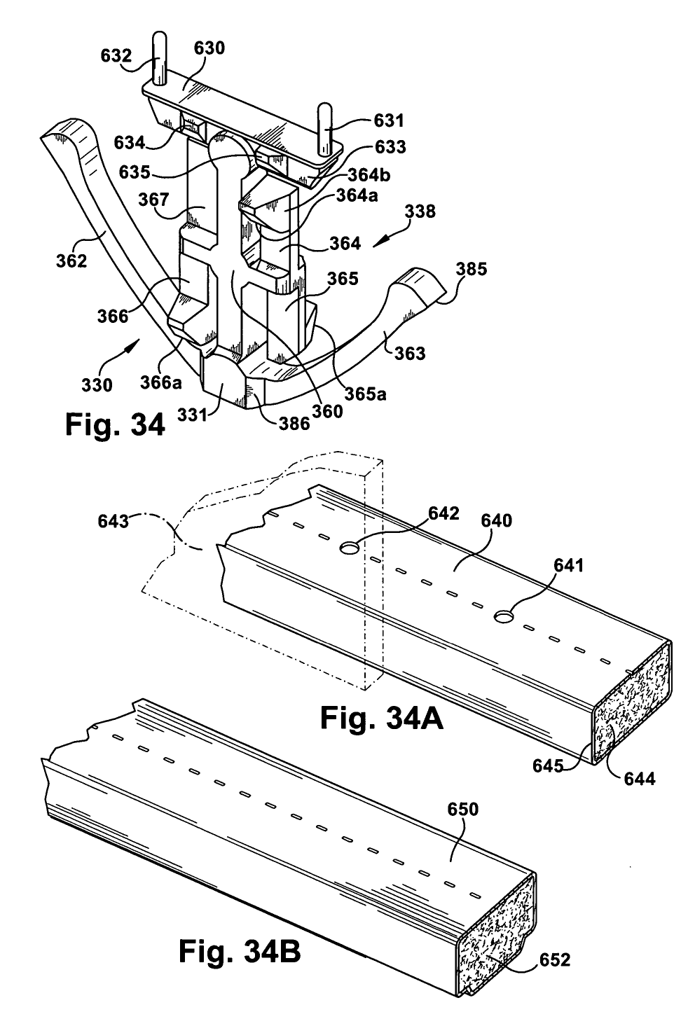

The use of the clip is not limited to U shaped spacer frame but is also used with box and foanframes as illustrated in FIGS. 34-37. The clip can also be used with so called swiggle frames. The clip of 330 of FIG. 34 engages a frame 640 that is a box spacer that is generally rectangular in section including outwardly facing side walls 645 that support a glass sheet 643 by means of an adhesive and is filled with a bulk dessicant 644 and further wherein the spacer includes locating holes 641, 642 that define a position of the clip and wherein an engagement between the clip and said holes is by means of locating pins 631, 632 extending from the frame engaging body 630. The clip of FIG. 34 can also be used with a box spacer 650 that is irregular along one wall having a center section 652 that is thicker than two bounding side portions such as the spacer of FIG. 34B. As seen in FIG. 34 the frame engaging body 630 includes side lobes 634, 635 that extend from a side wall 633 of the body 630 which act as side wall guides for a muntin bar bottoms as it is fit over the clip.

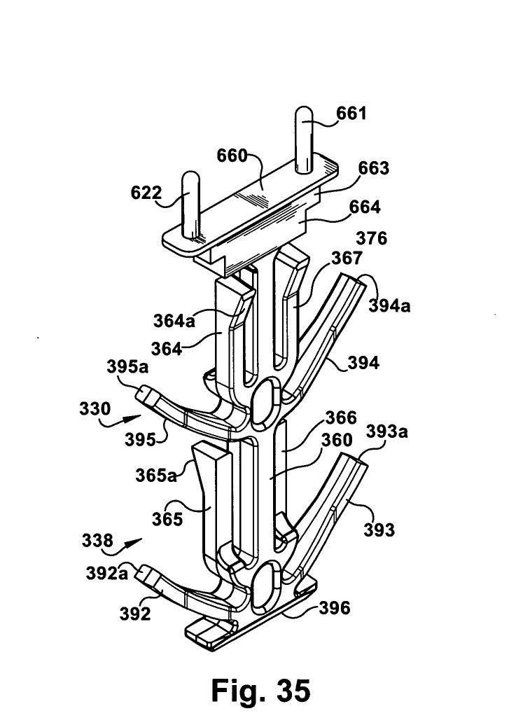

FIG. 35 illustrates a clip 330 wherein the frame engaging body 660 has pins 661, 662 and two steps 663, 664 and a platform that supports the pins 661, 662. The step 663 defines a surface against which the muntin bar bottoms out as it is pushed over the clip.

FIG. 36 illustrates a clip 330 for use with a frame that is a box frame of a thermoset foam and dessicant matrix combination 675 having an outer vapor barrier film 676 and includes a generally rectangular shape and further wherein the frame engaging body 670 of the clip includes an L shaped extension 674 having a lip 673 that extends along a side of the box frame that is treated with a structural adhesive for bonding the glass to the frame, said glass and frame sandwiching the lip of said L shaped extension. The body 670 also has a trapezoidal shaped part that engages the muntin engaging part of the clip that includes a top 671 and beveled side 672 surfaces.

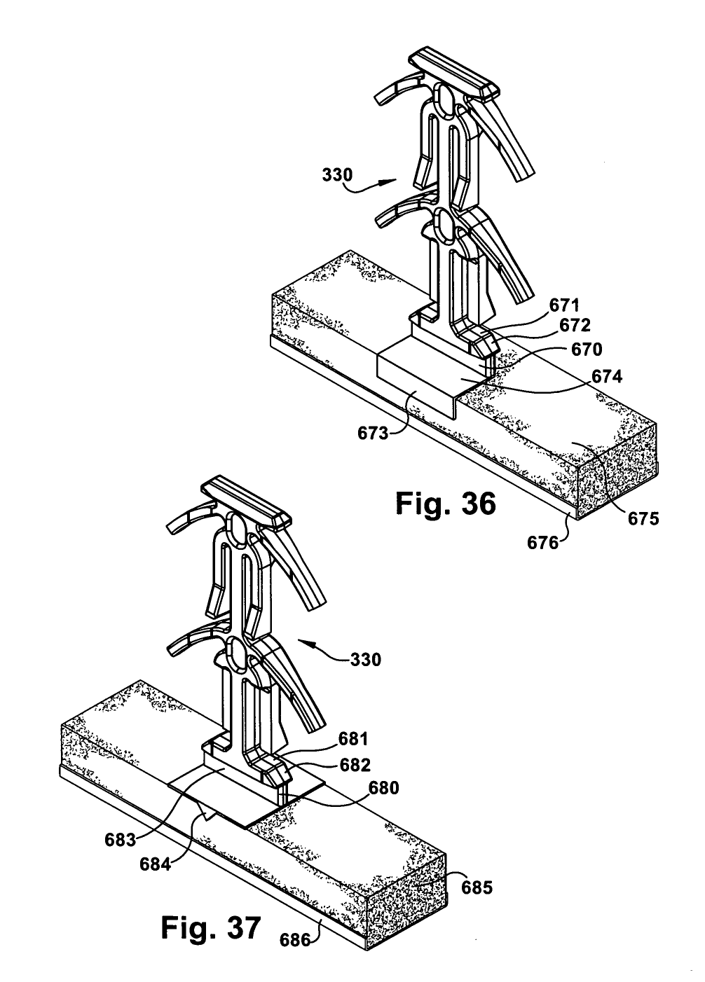

FIG. 37 illustrates a clip 330 wherein the frame comprises a silicon foam box spacer 685 having a vapor barrier film 686 along an outwardly facing side of said frame and wherein the frame engaging body 680 of the clip includes a generally flat contact region that engages the frame and further includes one or more prongs 684 along a side of the flat contact region that extend into the silicon foam box spacer. The body 680 has a narrow extension 682 that couples the flat contact portion of the body with a trapezoidal shaped portion. A flat top surface 681 facing the muntin bar provides a stop for movement as the clip is inserted into the muntin bar and a beveled or sloped portion 682 provides an overhang to provide a gap between the trapezoid and the flat frame engaging portion of the body 680. The overhang moves a final contact surface of the inner wall of the muntin bar up along the surface of the muntin bar.

While a preferred embodiment of the invention has been illustrated and described in detail, the present invention is not to be considered limited to the precise construction disclosed. For example, although disclosed with a spacer frame, the disclosed muntin bar clip could be used to mount the muntin assembly to a window sash having an elongated channel extending about a window frame sash.

1. For use with a spacer frame having opposed walls bounding an elongated channel extending around a periphery of said frame, a muntin bar clip comprising:
a spacer frame engaging body for insertion into a channel of the spacer frame and including a flexible body portion which flexes from a first configuration that is wider than a spacing between an entrance to the opposed bounding walls to a second configuration that allows the clip to be pushed into the spacer frame to exert an outward securing force against the spacer frame;
a muntin bar engaging body attached to the spacer frame engaging body having a flexible portion that flexes as the muntin bar engaging body is pushed into the muntin bar.

2. The apparatus of claim 1 wherein the spacer frame has a flange along opposed sides of the channel and notches in the flange that define muntin bar positions and further wherein the spacer frame engaging body includes projections that extend into the notches in the flange.

3. A method for mounting a muntin bar to a spacer frame having opposed walls that define a channel comprising
inserting one end of a muntin bar mounting clip into one end of an elongated muntin bar;
flexing an opposite end of the mounting clip until said clip can be inserted between the opposed walls of said spacer frame; and
releasing the opposite end of the mounting clip so that outward forces are asserted agains walls of a channel of the spacer frame.

4. The method of claim 3 additionally comprising:
providing projections on opposite sides of the clip that extend into notches in a flange of the frame that border the channel as the clip is being flexed.

5. For use with a window sash having an elongated channel extending around an inner periphery of said sash, a muntin bar clip comprising:
a sash engaging body for insertion into a channel of the sash and including a flexible body portion which flexes from a first configuration to a second configuration as the clip is pushed into the sash to exert an outward force against walls of the sash bounding the elongated channel;
a muntin bar engaging body attached to the sash engaging body having a flexible portion that flexes as the muntin bar engaging body is pushed into the muntin bar.

6. For use with a spacer frame having opposed walls bounding an elongated channel extending around a periphery of said frame, a clip comprising:
a spacer frame engaging body for insertion into a channel of the spacer frame and including a flexible body portion which flexes from a first configuration to a second configuration as the clip is pushed into an entrance to the channel to exert an outward securing force against the spacer frame;
a support attached to the spacer frame engaging body that supports structure inside a region bounded by the spacer frame.

7. The clip of claim 6 wherein the spacer frame engaging body comprises a center section coupled to the support and outwardly extending flexible side sections that span a region between the opposed walls.

8. The clip of claim 7 wherein the outwardly extending flexible side sections comprise two interconnected polygons that flex for insertion into a spacer frame channel for contacting opposite sides of said channel and maintain the clip in engagment with said spacer frame.

9. The clip of claim 7 wherein the outwardly extending flexible side sections comprise curved elongated legs that extending outwardly from the center section having a curved extent sufficient to span a width of a spacer frame channel.

10. The clip of claim 7 wherein the outwardly extending flexible side sections comprise first and second flexible wedge shaped portions that flex inwardly as they are inserted into a spacer channel.

11. The clip of claim 7 wherein the outwardly extending flexible side sections comprise an oval shaped member that spans a width of a spacer channel.

12. The clip of claim 11 additionally comprising an elongated beam that extends from the oval shaped member to connect said oval shaped member to the support.

13. The clip of claim 7 wherein the outwardly extending flexible side sections comprises first and second sets of deflectable fingers having distal portions that engage side walls of a spacer frame channel.

14. The clip of claim 11 wherein the support is offset within the channel and connected to an elongated side of the oval shaped member that spans the width of the spacer channel.

15. The clip of claim 7 wherein the outwardly extending flexible side sections comprise lobes that are flexed inwardly to fit into the channel of said spacer frame and then flex outwardly to secure said clip to the spacer frame.

16. The clip of claim 7 wherein the outwardly extending flexible side sections comprise a bend flexible leg having multiple generally flat portions for contacting inner surfaces of the spacer frame channel.

17. The clip of claim 6 wherein the support comprises an elongated stem that extends away from a center portion of the spacer frame engaging body portion and has fingers that extend outwardly away from the stem.

18. The clip of claim 17 wherein the fingers have latching members along an outer surface.

19. The clip of claim 17 wherein the fingers have outer surfaces that include an array of slots that extend into said outer surfaces.

20. The clip of claim 17 wherein the support comprises a distalmost set of two fingers and an intermediate set of two or more fingers.

21. The clip of claim 20 wherein the fingers are thicker near a region of engagement with the elongated stem and narrow near their ends.

22. The clip of claim 6 wherein the support engages a muntin bar and said support comprises
a) a center spine attached to the spacer frame engaging body and that extends away from said spacer frame engaging body into the muntin bar; and
b) pairs of elongated flexible fingers that extend longitudinally along opposite sides of the spine and which extend outwardly from the spine at angles to contact an inner wall of the muntin bar at spaced locations on oppositely spaced first and second walls of the muntin bar to frictionally engage and align said muntin bar with respect to the spacer frame.

23. The clip of claim 22 wherein the fingers of the support that extend from a side of said spine form a subtended angle of between 10 and 20 degrees.

24. The clip of claim 23 wherein the subtended angle is approximately 14 degrees.

25. The clip of claim 6 wherein the clip comprises a spacer frame engaging body that is molded as a separate part and that detachably engages the support.

26. The clip of claim 6 wherein the clip comprises a flexible spacer frame engaging body that flexes between the first and second configurations for use with spacer frames having a separation between walls in a range that varies by ⅛ inch to be used with multiple spacer frame widths.

27. For use with a spacer frame having an elongated channel extending around an inner periphery of said frame, a clip comprising:
a spacer frame engaging body for insertion into a channel of the spacer frame and including a body portion having an array of fingers that form a notch which flex from a first configuration to a second configuration as a spacer frame flange is inserted into the notch formed by the array of fingers to exert a retaining force to maintain the clip within the walls of the spacer frame bounding the frame channel; and
a support attached to the spacer frame engaging body that supports structure inside a region bounded by the spacer frame.

28. The clip of claim 27 wherein the spacer frame engaging body includes an array of extentions that extend into a dessicant material covering a portion of a wall of the spacer frame.

29. The clip of claim 27 wherein there are multiple fingers on each side of the notch wherein one or more of the multiple fingers extend into notch in the spacer frame and others of the multiple fingers slid over a flange of the spacer frame.

30. For use with a frame, a clip for supporting a muntin bar and attaching the muntin bar to said frame comprising:
a frame engaging body for connecting the muntin bar to the window including a body portion which contacts the frame to exert a securing force against the frame and maintain engagement between said frame and said clip;
a muntin support attached to the frame engaging body that supports a muntin bar inside a region bounded by the frame, said muntin support comprising:
a) a center spine that extends from the frame engaging body into the muntin bar and is bound by walls of said muntin bar;
b) a set of first and second elongated fingers coupled to the spine at an angle and having a length to engage side walls of the muntin bar as the spine enters the muntin bar and flexes inward toward said spine to exert a sufficient force against an inner wall surface of said muntin bar.

31. The clip of claim 30 wherein the finger extends away from the spine at an angle of between 55 and 65 degrees.

32. The clip of claim 30 having one set of fingers extending away from the spine in one direction and a second set of fingers extending away from the spine in an orthogonal direction to contact adjacent orthogonal walls of the muntin bar.

33. The clip of claim 32 wherein one set of fingers attaches to a center portion of the spine and includes a ramp portion that engages inner walls of the muntin bar.

34. The clip of claim 32 wherein one set of fingers comprises a wiper that bends as it comes into contact with an inner wall of the muntin bar.

35. The clip of claim 30 wherein the sufficient force between the finger and the wall of the muntin bar is between 0.5 and 1.5 pound regardless of the amount of bending for different dimensions muntin bars.

36. The clip of claim 30 wherein the length of the finger is between 0.6 and 0.8 inches.

37. The clip of claim 30 wherein the finger is generally rectangular in section and has a thickness dimension of 0.04 to 0.06 inches and a width dimension of 0.07 to 0.10 inches.

38. The clip of claim 30 wherein the frame comprises a box spacer that is generally rectangular in section including outwardly facing side walls that support a glass sheet by means of an adhesive and is filled with a bulk dessicant and further wherein the spacer includes locating holes that define a position of the clip and wherein an engagement between the clip and said holes is by means of locating pines extending from the frame engaging body.

39. The clip of claim 38 wherein the box spacer is irregular along one wall having a center section that is thicker than two bounding side portions.

40. The clip of claim 38 wherein the frame engaging body includes side lobes against which a muntin bar engages as it is fit over the clip.

41. The clip of claim 30 wherein the frame is a frame is a box frame of a thermoset foam or corregated flexible steel sealant/foam combination and dessicant matrix combination having an outer vapor barrier film and includes a generally rectangular shape and further wherein the frame engaging body of the clip includes an L shaped extension having a lip that extends along a side of the box frame treated with a structural adhesive for bonding the glass to the frame, said glass and frame sandwiching the lip of said L shaped extension.

42. The clip of claim 30 wherein the frame comprises a silicon foam box spacer having a vapor barrier film along an outwardly facing side of said frame and wherein the frame engaging body of the clip includes a generally flat contact region that engages the frame and further includes one or more prongs along a side of the flat contact region that extend into the silicon foam box spacer.
